(19) United States
(12) Patent Application Publication
(10) Pub. No.: US 2004/0129074 A1
(43) Pub. Date: Jul. 8, 2004

(54) Sensor capable of operating outside of ambient operating temperature limits

(76) Inventors: Paul Rudewicz, Mission Viejo, CA (US); Michael Vasquez, Canyon Lake, CA (US)

Correspondence Address: Marvin H. Kleinberg, Suite 1080, 2049 Century Park East, Los Angeles, CA, 90067, US

(21) Appl. No.: 10/336,488

(22) Filed: Jan. 3, 2003

(51) Int. Cl. G01F 23/00

(52) U.S. Cl. 73/295; 73/304 R

(57) ABSTRACT

A sensor capable of operating in ambient temperatures that are either above or below operating systems specification. comprises a transducer adapted to be coupled to a power supply for generating signals corresponding to and representative of the status of the targeted system. Signal conditioning means are coupled to the transducer and are responsive to generated signals. The signal conditioning means produces status signals in a format that is compatible with an information utilization device. A thermo electric module is attached to the signal conditioning means for changing the temperature of the signal conditioning means. In an alternative embodiment, the thermo electric module is connected to control the environment in which the signal conditioning means operate. The signal conditioning means are then able to operate in ambient temperatures that are outside of the normal operating parameters to which the to which the signal conditioning means were originally designed.

### CROSS-REFERENCE TO RELATED APPLICATIONS

This application is a continuation-in-part of our U.S. Provisional Application Ser. No. 60/231,400, filed Jun. 23, 2000.

### FIELD OF THE INVENTION

The present invention relates to apparatus to sense status states in a target system and, more particularly, a sensing device capable of operating in temperature environments that are above or below the specified ambient operating temperatures for such a device.

The preferred embodiment of the present invention is directed towards fluid level sensors for fluids contained within a closed vessel. However, one skilled in the art will note that the claimed invention is applicable to any sensor apparatus which is required to operate in an environment that is either above or below specified operating temperature limits.

It is important to detect liquid levels in fuel and lubrication systems for prime movers of various sorts. Typical prior art approaches include sticks or probes that can be inserted into a container for the fluids. Where the container is not readily accessible or is in a hostile environment, either because of ambient temperatures or because of other environmental challenges, it has been desirable to provide transducers which can determine fluid level and signal such determinations to a remote instrument that displays fluid level or to an alarm system, in the event that the fluid levels are inadequate according to a predetermined criterion.

The prior art has taught capacitive sensors for fluids with circuitry for providing a readout at a remote location. Typical prior art approaches, which may be adapted for use in the present invention, are taught in the patents to Kuhlman, U.S. Pat. No. 4,515,015; and Brenner, et al, U.S. Pat. No. 5,973,415.

In engines that operate at extreme temperatures, such as in jet aircraft or internal combustion or diesel engines that operate at temperatures either far above or below the normal operating parameters of electronic circuits, special instrumentation must be devised that either employs components that are rated at the extreme temperatures or that remove the electronic components from the regions of extreme temperatures.

Where a lubricating, operating or coolant fluid is involved, rather than a fuel which is depleted during normal operation, it is necessary to know when the fluid levels approach levels that cannot sustain adequate operation. Usually, fluid levels are checked prior to operation of the machinery. In some special situations, fluid levels might be checked, if accessible, during operation or special level sensors can be employed that can function in hostile environments. The need arises as well for sensors monitoring conditions in other devices.

What is needed, and what is provided by the present invention, is a sensor that can be targeted to a specific system to be monitored and that includes transducing circuitry coupled to the sensor and subjected to the extreme temperatures of the apparatus and the ambient environment. The circuitry, using more or less conventional electronic components that are designed to operate in more temperate environments, is kept within tolerable operating temperature limits by heating/cooling elements. These elements may be located in close proximity to said circuitry or may be applied to a closed environment housing said circuitry that is remotely coupled to the sensors.

### SUMMARY OF THE INVENTION

According to the present invention, a rugged sensor is provided that can be placed within a target environment and which relies upon electronic circuits to identify system status states within the selected environment and transmit those states to remote displays or information utilization devices, such as a computer or instrument panel. The electronic circuit modules can be mounted adjacent the sensor but can operate within the normal operating parameters of commercial circuits because of various facets of the invention.

In a preferred embodiment of the present invention, a capacitive sensor, consisting of concentric conductive cylinders is suspended in a fluid reservoir. The capacitance between the cylinders is a function of the dielectric medium that, in one case would be the fluid whose level is being monitored and air or other atmosphere that exists in the absence of fluid.

At the base of the sensor, a reference capacitive element is provided to correct for variations in the dielectric coefficient and temperature of the fluid to be measured. If there is no fluid covering the reference capacitor, the circuitry will signal minimum fluid levels. As the fluid level rises, the reference capacitor is affected by the fluid and a baseline signal is generated.

With greater fluid levels, more and more of the cylindrical elements will be immersed and the capacitance will change, increasing in value in direct proportion to the height of the fluid. Appropriate electronic circuits convert the capacitance value into a signal that can be transmitted to data processing equipment and display devices.

Because the measured capacitance can be affected by capacitances encountered in the environment of the reservoir, it is desirable that the electronic circuitry be positioned as closely to the cylinders as is possible. The electrical signals produced by the circuitry, which correspond to and are representative of the fluid level in the reservoir, are much less liable to interference or errors in the transmission of data to display or data processing systems. However, it is possible to contain the sensors within an environment that is loosely coupled to the device being monitored.

In the preferred embodiment, the electronic circuits are mounted upon heat sinks that are connected to thermo-electric elements that provide refrigeration or heat, depending upon the flow of electrical current applied thereto. These thermo electric modules are commercially available from several sources throughout the world but the modules selected for the present invention are preferably acquired from TELLUREX Corporation of Traverse City, Mich.

In an alternative embodiment, the electronic circuits are contained within a closed environment and the temperature within the entire closed environment is maintained within pre-determined reasonable operating limits. In this embodiment, the closed environment may be either tightly or loosely coupled to the sensors.

In one embodiment used with a lubricating oil reservoir on a jet aircraft engine, it was determined that the temperature of the oil in the tank was approximately 325° F. (or 163° C.) With an ambient air temperature of approximately 250° F. (121° C.), the normal operating limits for electronic components of −55° C. to 125° C. are challenged in that, at best, there is a 4° C. margin, believed to be inadequate when specifying components for an application.

According to the present invention, a cold plate assembly fitted with thermo electric (Peltier effect) modules is able to lower the temperature of the components by approximately 30° C. bringing operating conditions well within the operational range for reliable operation.

Obviously, other applications that require greater temperature reductions to reach the operational temperature ranges could employ more or larger thermo electric modules to achieve greater temperature reductions.

Typical applications in which the present invention would be useful include large diesel engines in earth moving and construction equipment, trucks, busses, locomotives, marine engines, and power generating plants. Large internal combustion engines could also benefit from fluid measurement systems according to the present invention. Similarly, jet or turbine engines, whether in land, sea or air based applications could usefully employ the systems of the present invention.

Because thermoelectric elements can be used in heating as well as cooling operations, it is also possible to utilize the present invention in conjunction with equipment that must operate in extremely low temperatures such as are found at high altitudes or in the polar regions where temperatures routinely fall below the lower operating temperature limits for electronic components.

It is therefore an object of the present invention to provide an sensor system signal conditioning means that can function in ambient temperatures that are outside of the normal operating parameters to which the signal conditioning means were designed.

It is an additional object of the invention to provide a simple capacitive fluid level sensor which can operate in elevated fluid temperatures and whose electronics may also operate in temperatures that are generally out of the normal thermal range for electronic components.

It is a further object of the invention to provide electronic circuitry for a transducer, which circuitry can operate in extreme temperatures that are outside of the operating temperature range of electronic components.

The novel features which are characteristic of the invention, both as to structure and method of operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

FIG. 1 is a sectional view of a tank fitted with a level sensor according to the present invention;

FIG. 2 is a side view of a capacitive sensor useful in the present invention;

FIG. 3 is a side sectional view of the sensor of FIG. 2;

FIG. 4 is side sectional view of a printed circuit board with an incorporated thermo electric element

FIG. 4A is side sectional view of a printed circuit board and a thermo electric element contained within a closed environment and remotely coupled to sensor(s)

FIG. 5 is a block diagram of an electronic circuit useful in the present invention;

FIG. 6 including FIGS. 6A and 6B shows typical waveforms with an empty tank; and

FIG. 7, including FIGS. 7A and 7B shows typical waveforms with a full tank.

### DESCRIPTION OF THE PREFERRED EMBODIMENTS

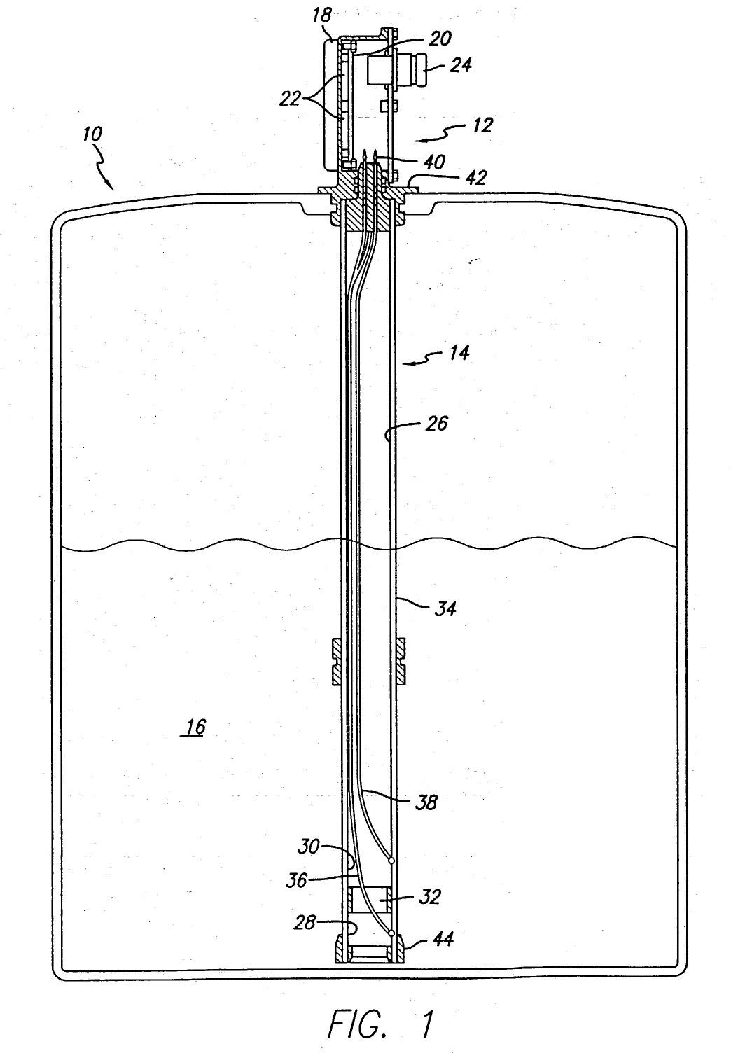

Turning first to FIG. 1, there is shown, in side section, a tank 10 into which the fluid level sensor 12 of the present invention is installed. The sensor 12, includes a cylindrical capacitive transducer assembly 14 which is located in the interior of the tank 10 and adapted to be in contact with the fluid 16 whose level is to be measured.

As a part of the level sensor 12 which is mounted outside of the tank 10, there is housing 18 which encloses a printed circuit board assembly 20 that includes a thermo electric element 22. The circuit board assembly 20 is explored in greater detail in FIG. 4, below.

As seen in FIGS. 1 and 3, but shown in greater detail in FIG. 3, the transducer assembly 14 includes an inner cylindrical element 26 which includes a lower portion 28 that is insulated and isolated from an upper portion 30 by an insulating collar 32. The transducer assembly 14 also includes an outer cylindrical element 34 that is continuous and uninterrupted. A first conductor 36 is connected to the lower portion 28 and a second conductor 38 is connected to the upper portion 30. Both the first and second conductors are connected to a terminal block 40 that permits electrical connection to the electronic signaling circuits.

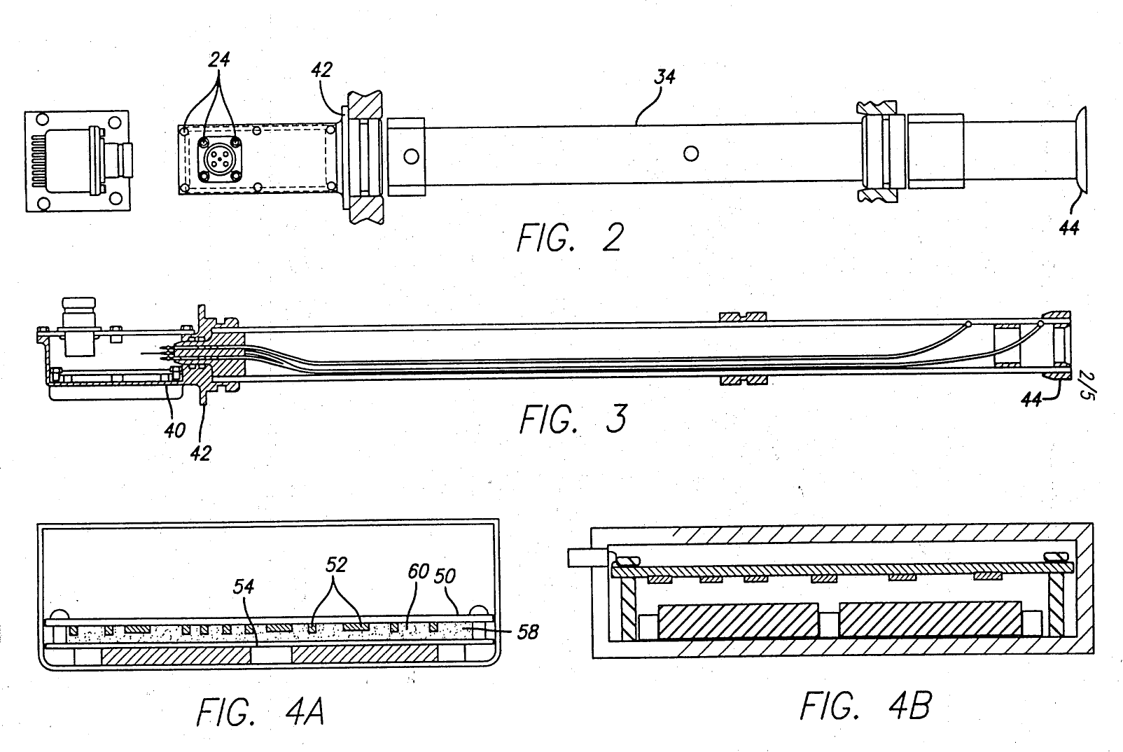

In FIG. 2, the sensor system 12 is seen from a side view. An electrical connector 24 is provided so that signals generated within the sensor assembly 12 can be transmitted and power can be applied to the electrical components within the sensor assembly 12. A mounting collar 42 cooperates with mounting elements on the tank structure to install the sensor system 10 in the tank 12. An end cap 44 maintains the spacing between the inner and outer cylindrical elements 26, 34 and admits fluid to the interior of the sensor assembly 10.

In FIG. 3, the interrelationship between the inner and outer cylindrical elements 26, 34 can be seen in somewhat greater detail. As shown, the outer cylindrical element 34 is connected through the mounting collar 42 to a common reference potential source indicated by the ground symbol. The shield of the coaxial cable to the inner cylindrical element 26 is also connected to the source of common reference potential. Accordingly, as the fluid level within the cylindrical elements rises, the capacitance between the inner and outer cylindrical elements changes, as the dielectric value of the fluid is different from that of air.

Turning next to FIG. 4, there is shown in side section, a view of the printed circuit board 50. As shown, the printed circuit board components 52 are mounted adjacent a thermally conductive plate 54 to which is mounted the thermo electric elements 56. To maximize the thermal transfer, the cavity 58 between the board 50 and the plate 56 is filled with a compound 60 of high thermal conductivity.

In an alternative embodiment, shown in FIG. 4A, the printed circuit board 50 is mounted within a closed environment. Thermo electric elements within the environment are mounted so as to maintain the environment at a temperature that is within the specific normal operating parameters of the circuit board components 52 and the printed circuit board 50.

In the preferred embodiment, the thermo electric elements 56 are connected for cooling so that the circuit board components 52 are kept at a temperature that is well below the ambient temperature of the tank and the fluid contained therein. Knowing the expected ambient temperatures, the thermo electric elements can be selected to provide the desired temperature differential to assure that the components 52 are operating well within their rated temperature ranges.

Where the ambient temperatures are near or below the lower temperature limits for operating electronic circuitry, the thermo electric elements could function as heaters. This operational mode would increase the temperature of the electronic components to a value that is comfortably within safe operating temperature is parameters.

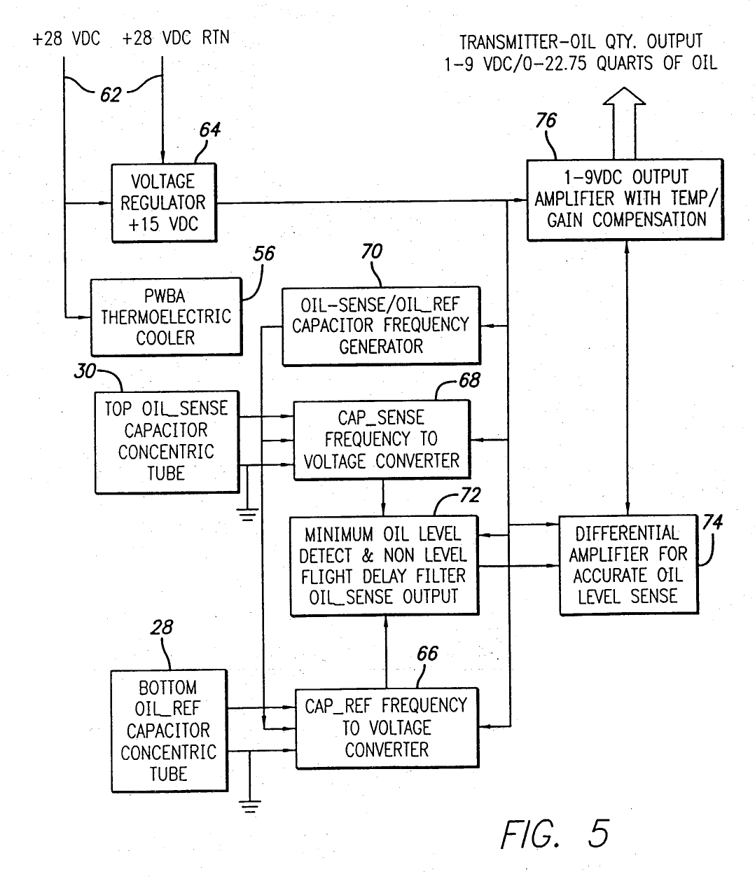

FIG. 5 is a block diagram of the electronics that enables the signaling of the fluid levels of the tank 10. As shown, a power supply 62 is a source of electrical energy for the system. A voltage regulator 64 reduces the voltage for those circuit elements whose operational requirements mandate a lower voltage. As noted above, the inner cylindrical sensor element 26 is electrically subdivided into a lower portion 28 and an upper portion 30. The lower portion 28 is connected to a first capacitance driven frequency to voltage converter 66 and the upper portion 30 is connected to a second capacitance driven frequency to voltage converter 68. Both frequency to voltage converters 66, 68 are controlled by a frequency generator 70.

The first and second frequency to voltage converters 66, 68 have their outputs applied to an output device 72 which is connected to a differential amplifier 74 which provides an output representative of an accurate oil level reading. The differential amplifier 74 is connected to an output amplifier 76 that transmits a signal to the data management equipment, signaling the fluid level in the tank.

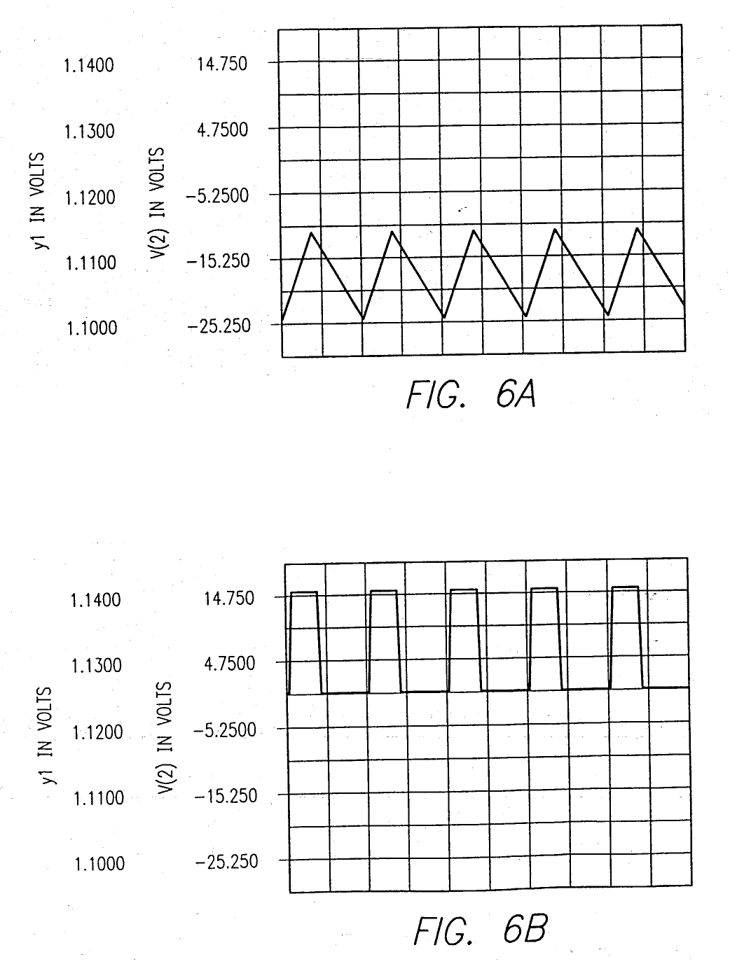

In FIG. 6, including FIGS. 6A and 6B, is a graph of typical waveforms for the tank when empty. FIG. 6A is the waveform representing the pulse width input into an averaging filter and FIG. 6B represents the output of the averaging filter. In one test circuit, approximately ⅓ or 12.5 microseconds were the duration of a pulse over a period of 40 microseconds. In the test circuit, the peak-to-peak voltage was 12.887 volts with an average voltage of 1.1074 volts.

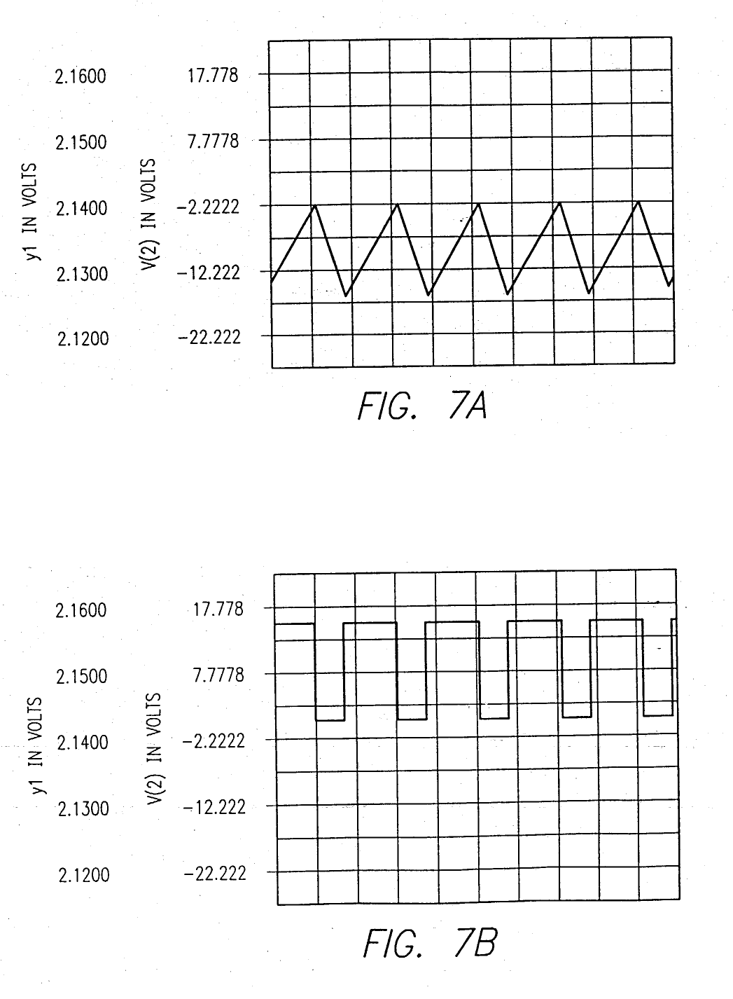

In FIG. 7, including FIGS. 7A and 7B, the comparable wave forms are shown for a full tank condition. As shown in FIG. 7a, the pulse width is 25 microseconds with the same 40-microsecond period. The 12.5 microsecond difference in pulse width represents the difference between a full and empty tank. As seen in FIG. 7B, the output waveform had a peak to peak voltage of 12.776 volts and an average voltage of 2.1328 volts. The difference of approximately 1.0 volt at the output can be the basis for calibrating the display in that the output voltage represents the volume of fluid in the tank.

Known circuits can convert the capacitance value to a pulse width within each period. By averaging the signal, the voltage is proportional to the volume of fluid in the tank. This analog information can be transmitted either in analog or digital form to the information handling systems that will display a reading representative of the amount of fluid in the tank.

Thus there has been shown and described, a sensor designed in the preferred embodiment to sense target states in a system and to work in extreme conditions of heat or cold. A novel capacitive sensor has been disclosed together with a thermo electric module that maintains the electronic circuits at a temperature within normal operating ranges for the electronic components, notwithstanding the extreme ambient temperatures. However, the invention should not be so restricted but should only be limited by the scope of the claims appended hereto. Signal conditioning means were originally designed.

What is claimed is:

1. A fluid level sensor comprising:
a. a fluid level transducer adapted to be coupled to a power supply for generating signals corresponding to and representative of the level of a fluid in a reservoir;
b. signal conditioning means coupled to said transducer and responsive to generated signals for producing fluid level signals compatible with an information utilization device; and
c. thermo electric module means in intimate thermal contact with said signal conditioning means for changing the temperature of said signal conditioning means whereby said signal conditioning means can operate in ambient temperatures that are outside of the normal operating parameters to which said signal conditioning means were designed.

2. The apparatus of claim 1, above wherein said thermo electric module means are connected to cool said signal conditioning means from ambient temperatures greater than the normal operating parameters of said signal conditioning means to a lower operating temperature that is within the normal operating parameters for such signal conditioning means.

3. The apparatus of claim 1, above wherein said thermo electric module means are connected to heat said signal conditioning means from ambient temperatures that are less than the normal operating parameters of said signal conditioning means to a higher operating temperature that is within the normal operating parameters for such signal conditioning means.

4. The apparatus of claim 1, above, further including heat sink means in intimate thermal contact with said signal conditioning means and said thermo electric module means for optimizing thermal transfer therebetween.

5. The apparatus of claim 1, above, wherein said transducer comprises:
a. a first electrically conductive element having an upper portion, a lower portion and an insulating section intermediate said upper and lower portions for electrically isolating said portions from each other;
b. a second electrically conductive element substantially parallel to said first element;
c. a terminal block;
d. a first conductor electrically connecting said first element upper portion to said terminal block;
e. a second conductor electrically connecting said first element lower portion to said terminal block;
f. means coupling said second element to a source of common reference potential; and
g. circuit means coupled to said terminal block for utilizing the capacitance between said first and second elements to generate signals corresponding to and representative of the quantity of a dielectric medium between said first and second elements whereby the change in capacitance resulting from the presence of a liquid between said first and second elements can be indicative of the quantity of the liquid.

6. A fluid level sensor comprising:
a. a fluid level transducer adapted to be coupled to a power supply for generating signals corresponding to and representative of the level of a fluid in a reservoir comprising;
i. a first electrically conductive element having an upper portion, a lower portion and an insulating section intermediate said upper and lower portions for electrically isolating said portions from each other;
ii. a second electrically conductive element substantially parallel to said first element;
iii. a terminal block;
iv. a first conductor electrically connecting said first element upper portion to said terminal block;
v. a second conductor electrically connecting said first element lower portion to said terminal block;
vi. means coupling said second element to a source of common reference potential; and
vii. circuit means coupled to said terminal block for utilizing the capacitance between said first and second elements to generate signals corresponding to and representative of the quantity of a dielectric medium between said first and second elements;
b. signal conditioning means coupled to said transducer means terminal block and responsive to generated signals for producing fluid level signals compatible with an information utilization device; and
c. thermo electric module means in intimate thermal contact with said signal conditioning means for changing the temperature of said signal conditioning means whereby said signal conditioning means can operate in ambient temperatures that are outside of the normal operating parameters to which said signal conditioning means were designed.

7. The fluid level sensor of claim 6, further including differential amplifier means coupled to receive signals representative of the capacitance measured by said first element upper portion and said first element lower portion whereby a difference in capacitance as between said lower and upper portions corresponds to and is representative of the fluid level in the reservoir.

8. The fluid level sensor of claim 6 wherein said transducer signals are values of capacitance as between said first and second conductors and said conditioning means include capacitance driven frequency to voltage converters whereby an output voltage is proportional to the fluid level between said first and second conductors.

9. Apparatus for extending the thermal range of electronic circuits comprising thermo electric module means in intimate thermal contact with the electronic circuits whose thermal range is to be extended, for changing the temperature of the electronic circuits whereby the electronic circuits are subjected to temperatures within their normal operating range while operating in ambient temperatures that are outside of the operating temperatures for which the electronic circuits were designed.

10. The apparatus of claim 9, above wherein said thermo electric module means are connected to cool the electronic circuits from ambient temperatures greater than the normal operating parameters of the electronic circuits to a lower operating temperature that is within the normal operating parameters for such electronic circuits.

11. The apparatus of claim 9, above wherein said thermo electric module means are connected to heat the electronic circuits from ambient temperatures that are less than the normal operating parameters of the electronic circuits to a higher operating temperature that is within the normal operating parameters for such electronic circuits.

12. The apparatus of claim 9, above, further including heat sink means in intimate thermal contact with the electronic circuits and said thermo electric module means for optimizing thermal transfer there between.

13. A sensor comprising:
a. a transducer adapted to be coupled to a power supply for generating signals corresponding to and representative of the status of a targeted environment comprising;
i. a first electrically conducting element having an upper portion, a lower portion and an insulating section intermediate said upper and lower portions for electrically isolating said portions from each other;
ii. a second electrically conductive element substantially parallel to said first element;
iii. a terminal block;
iv. a first conductor electrically connecting said first element upper portion to said terminal block;
v. a second conductor electrically connecting said first element lower portion to said terminal block;
vi. means coupling said second element to a source of common reference potential; and
vii. circuit means coupled to said terminal block for utilizing the capacitance between said first and second elements to generate signals corresponding to and representative of the quantity of a dielectric medium between said first and second elements;
b. signal conditioning means coupled to said transducer means terminal block and responsive to generated signals for producing state signals compatible with an information utilization device; and
c. thermo electric module means in intimate thermal contact with said signal conditioning means for changing the temperature of said signal conditioning means whereby said signal conditioning means can operate in ambient temperatures that are outside of the normal operating parameters to which said signal conditioning means were designed.

14. A sensor comprising:
a. transducer means for generation of a signal;
b. signal conditioning means coupled to said transducer means and responsive to said generated signals to provide output signals corresponding to and representative of an environment being monitored by the sensor; and
c. thermoelectric module means for maintaining the temperature of said signal conditioning means within predetermined limits coupled to said signal conditioning means.

15. The apparatus of claim 14, above, whereby said transducer is adapted to be coupled to a power supply.

16. A sensor comprising:
a. transducer means for generation of a signal;
b. signal conditioning means coupled to said transducer means and responsive to said generated signal;
c. closed environment means insulated from the ambient environment means housing said signal conditioning means
d. a thermoelectric module coupled to said closed environment for maintaining temperatures within normal operating limits of the components of said signal conditioning means whereby said signal conditioning means are environmentally protected to enable them to operate outside of the ambient temperature limits for which said signal conditioning means have been designed to operate.

17. The apparatus of claim 16, above, whereby said thermoelectric module contains means for changing the temperature inside said closed environment.

18. The apparatus of claim 16, above, whereby said transducer means are adapted to be coupled with a power supply.

19. The apparatus of claim 16, above, whereby said signal conditioning means are responsive to signals generated by said transducer for producing signals compatible with an information utility device.

20. A sensor comprising:
a. transducer means for generation of a signal;
b. closed environment means insulated from ambient conditions;
c. means containing signal conditioning means remotely coupled to said transducer means and responsive to said generated signals from said transducer means; and
d. thermoelectric module means coupled to said closed environment means.

21. The apparatus of claim 20, above, whereby said thermoelectric module means contains means for changing the temperature of said closed environment means.

22. The apparatus of claim 20, above, whereby said transducer means are adapted to be coupled with a power supply.

23. The apparatus of claim 20, above, whereby said signal conditioning means are responsive to signals generated by said transducer mans for producing signals compatible with an information utilization device.
